(19) United States
(12) Patent Application Publication
(10) Pub. No.: US 2007/0271111 A1
(43) Pub. Date: Nov. 22, 2007

(54) Method and system for recovering a dissatisfied customer by a customer recovery survey

(76) Inventor: George S. Dubinsky, Yardley, PA (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/638,453

(22) Filed: Dec. 14, 2006

Related U.S. Application Data
(60) Provisional application No. 60/800,847, filed on May 17, 2006.

(51) Int. Cl. G06Q 10/00; G06Q 30/00

(52) U.S. Cl. 705/1

(57) ABSTRACT

Systems and methods consistent with the present invention provide a dealer with an opportunity to recover dissatisfied customers and improve customer loyalty by identifying and sending recovery surveys to the dissatisfied customers. A dealer may review an online survey report containing customers' initial survey responses and initial scores. The dealer may identify a dissatisfied customer based on the customers' responses to the initial surveys. The dealer may contact the dissatisfied customer and attempt to resolve any concerns raised by the dissatisfied customer. The dealer may then request a recovery survey to be sent to the customer. The dealer may review an online report which contains customers' responses to the recovery surveys and a new score representing those recovered customers.

### RELATED APPLICATIONS

This application claims the benefit of priority of the U.S. Provisional Patent Application No. 60/800,847, entitled “METHOD AND SYSTEM FOR RECOVERING A DISSATISFIED CUSTOMER BY A CUSTOMER RECOVERY SURVEY,” filed May 17, 2006, which is incorporated herein by reference.

### BACKGROUND

1. Relevant Field

This invention relates generally to owner loyalty and customer satisfaction programs and more particularly to recovering dissatisfied customers using a customer recovery survey.

2. Background Information

It has become common for many automotive manufacturers and dealers to use surveys to gauge customer satisfaction with their products and experiences. In particular, nearly all automobile manufacturers mail out surveys on behalf of their dealers to receive feedback about customer satisfaction. Based on the survey responses received from the customers, the automobile manufacturers can identify problems and also rate the performance of each dealership. A dissatisfied customer who provides a negative survey response will likely not purchase a car from the same dealership in the future, and are therefore lost to the dealership. In some cases, a dissatisfied customer may also be lost to the manufacturer. Each negative survey response lowers the rating of the dealership in its performance evaluation. In this conventional survey system, however, the dealership has no tool for recovering a lost customer or improving its rating.

Systems and methods consistent with embodiments of the present invention address these and other drawbacks of conventional survey system.

### SUMMARY OF THE INVENTION

A customer recovery survey system consistent with embodiments of the present invention helps dealers to identify dissatisfied customers who may be potentially lost to the dealership and/or manufacturer. The customer recovery survey system provides a dealer with an opportunity to recover dissatisfied customers and improve customer loyalty. The customer recovery survey system also provides a dealer with an opportunity to improve an initial bad rating by recovering dissatisfied customers.

In accordance with embodiments of the present invention, methods and systems are disclosed for identifying dissatisfied customers and recovering dissatisfied customers using recovery surveys.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is a flow chart of a process for recovering dissatisfied customers consistent with an embodiment of the present invention.

FIG. 2 is a flow chart illustrating an exemplary process for a dealer to recover dissatisfied customers consistent with an embodiment of the present invention;

FIG. 3 is a flow chart illustrating an exemplary process for a customer to participate in a system for recovering dissatisfied customers consistent with an embodiment of the present invention;

FIG. 4 is a sample recovery survey report consistent with an embodiment of the present invention;

FIGS. 5-8 are sample screen shots depicting online survey reports consistent with an embodiment of the present invention;

FIG. 9 illustrates an exemplary prepaid business reply mail piece containing a sample recovery survey consistent with an embodiment of the present invention; and

FIG. 10 is a sample individual dealer report consistent with an embodiment of the present invention.

### DETAILED DESCRIPTION

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering, or adding steps to the disclosed methods. Accordingly, the following detailed description does not limit the invention. Instead, the proper scope of the invention is defined by the appended claims.

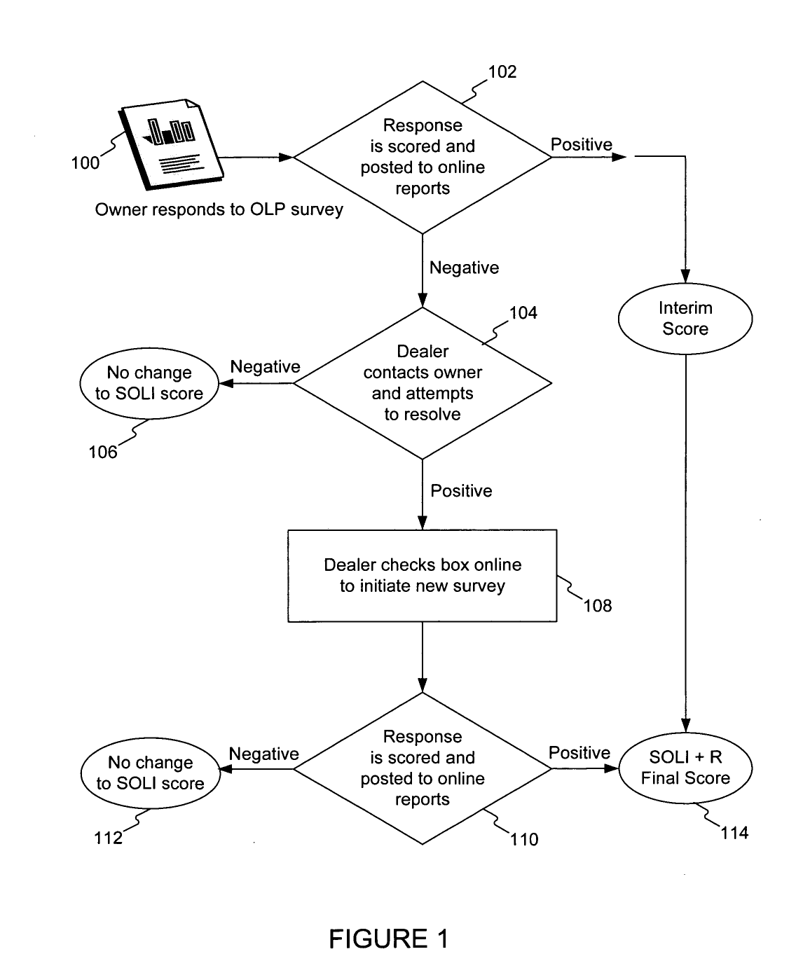

FIG. 1 is a flow chart of a process for recovering dissatisfied customers consistent with an embodiment of the present invention. An initial survey may be sent out to a customer who purchased a vehicle from a dealership or had a recent service visit (step 100). The survey may be sent, for example, by a manufacturer or by the dealer. In certain embodiments, the survey may be sent via mail or may be sent electronically. A response to the initial survey by the customer may be scored to yield an initial survey score, such as the Subaru Owner Loyalty Indicator “SOLI” score described in FIG. 1. An initial response and the SOLI score may be posted to online internet reports (step 102).

A dealer may then review an online survey report to identify a dissatisfied customer, e.g., a survey within a low SOLI score. The dealer may contact the dissatisfied customer and attempt to resolve any concerns raised by the dissatisfied customer (step 104). For example, the dealer may apologize to the customer or may offer to correct an error made by the dealership. If the dealer believes he failed to resolve the dissatisfied customer's concerns, the dealer may take no further action and no changes will be made to the SOLI score (step 106).

If the dealer believes he succeeded in resolving the dissatisfied customer's concerns, the dealer may simply check a box online to send out a recovery survey to the effected customer (step 108). Alternatively, the dealer may send the recovery survey himself.

The customer's response to the recovery survey may be scored and posted to online reports (step 110). If the customer's response to the recovery survey is negative, no change will be made to the SOLI score (step 112). However, if the customer's response to the recovery survey is positive, the SOLI score will be adjusted to yield an updated survey score, such as the “SOLI+” score (step 114). For example, the SOLI+ score may be an average of the SOLI score and a score based on the customer's response to the recovery survey.

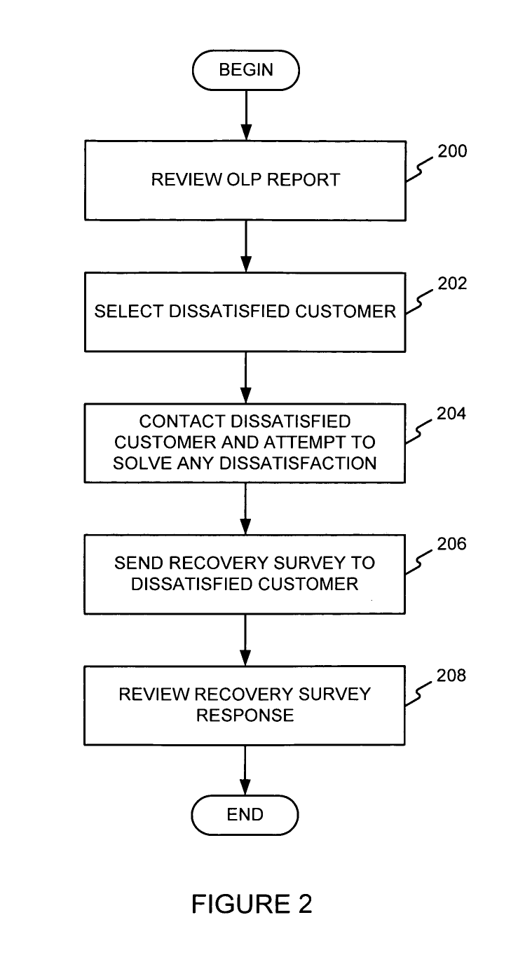

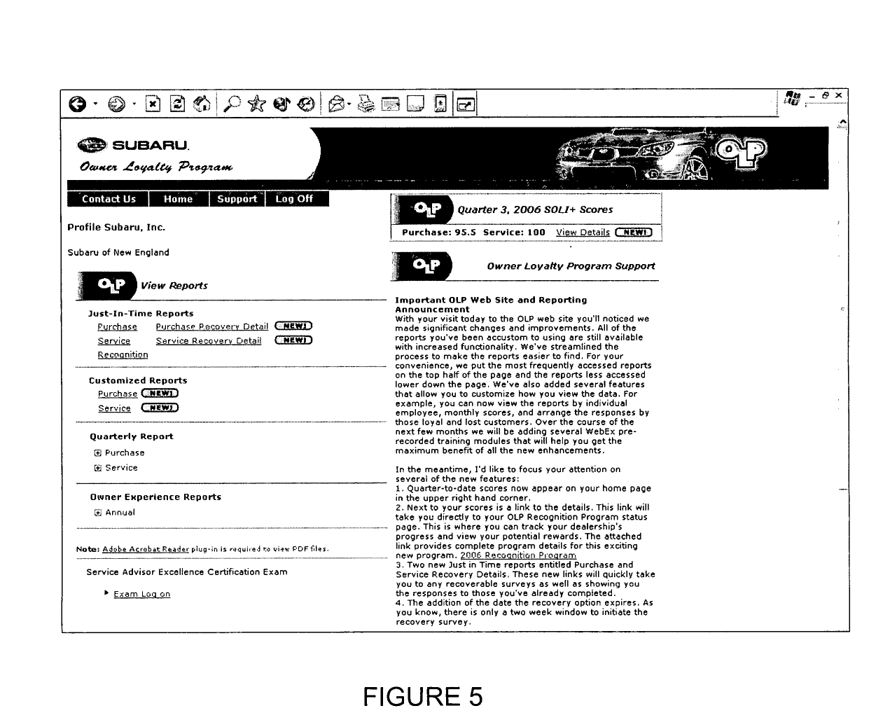

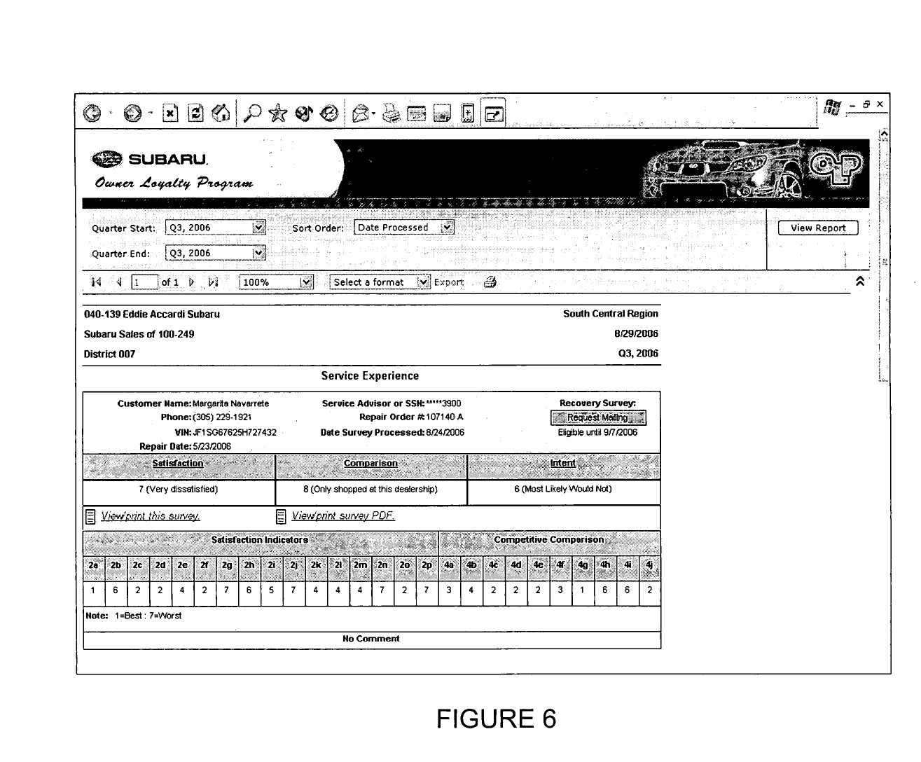

FIG. 2 is a flow chart illustrating an exemplary process for a dealer to recover dissatisfied customers consistent with an embodiment of the present invention. A dealer may review an online survey report, such as the Owner Loyalty Program Report (“OLP Report”), which contains customers' initial survey responses and the SOLI scores (step 200). FIG. 5 is a sample screen shot depicting a selection of dealer reports consistent with an embodiment of the present invention. In this example, the dealer may click on the Purchase or Service Recovery Detail hyperlink in the screen shot of FIG. 5 to view customers' initial survey responses, e.g., using an online survey report. FIG. 6 is a sample screen shot depicting such an online survey report consistent with an embodiment of the present invention.

After reviewing the online survey report, the dealer may select a dissatisfied customer, for example, based on the satisfaction score based on the customer's initial survey response (step 202). In the example of FIG. 6, the dealer may select Sample Customer as a dissatisfied customer because they provided a satisfaction score of 7 indicating they were very dissatisfied with some aspect of their experience with the dealer.

After the dealer has selected a dissatisfied customer, the dealer may contact the dissatisfied customer and attempt to solve any dissatisfaction (step 204). The dealer may, for example, listen to the customer's dissatisfaction and try to understand the nature of the dissatisfaction. The dealer may then, for example, attempt to solve any problems or may simply apologize for any problem or inconvenience.

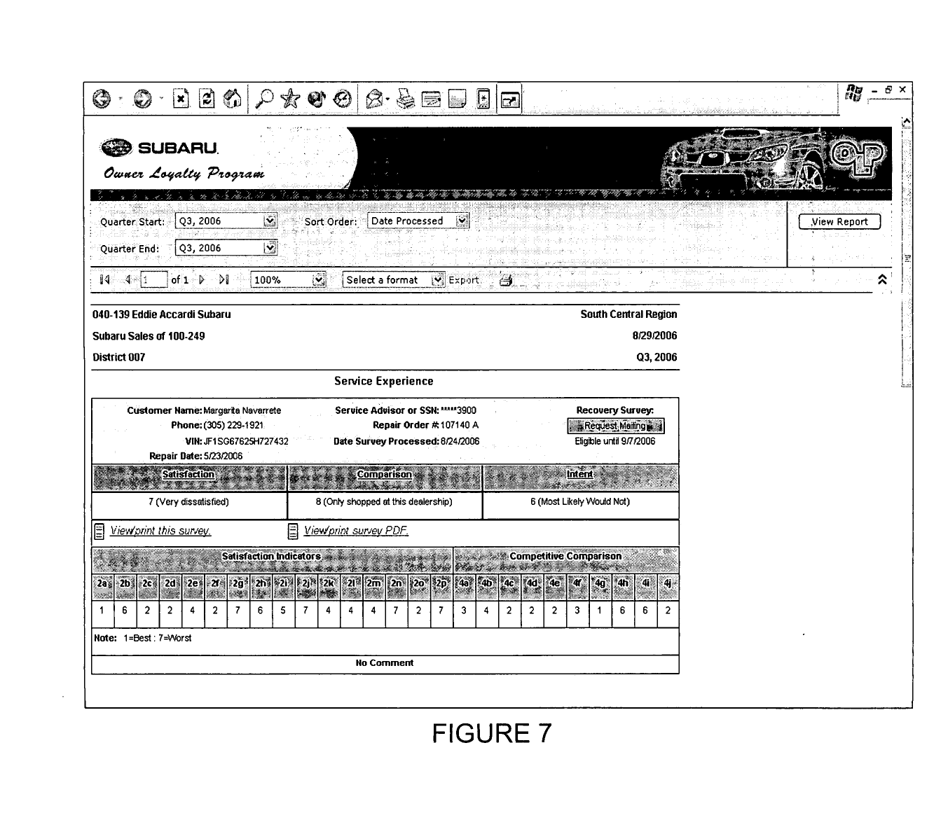

If the dealer believes he succeeded in resolving the customer's dissatisfaction, the dealer may send a recovery survey to the dissatisfied customer (step 206). In the example of FIG. 6, the dealer may click on the “Request Mailing” button in the screen to send a recovery survey. FIG. 7 is a sample screen shot depicting an online survey report consistent with an embodiment of the present invention. In this example, after the dealer has clicked on the “Request Mailing” button in the screen, the system may prompt the dealer to confirm that a recovery survey should be sent to the customer along with the expected date of mailing.

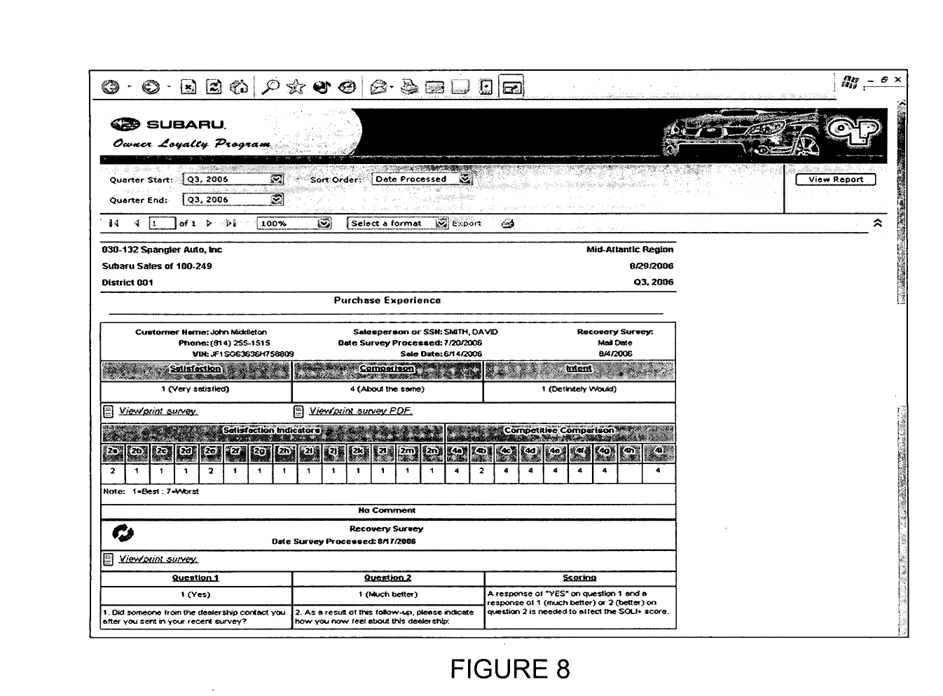

The dealer may review customers' responses to the recovery surveys (step 208). FIG. 8 is a sample screen shot depicting an online survey report showing customers' recovery survey responses. This report may show, for example, the date the customer's recovery survey was processed and the customer's response(s) to the recovery survey.

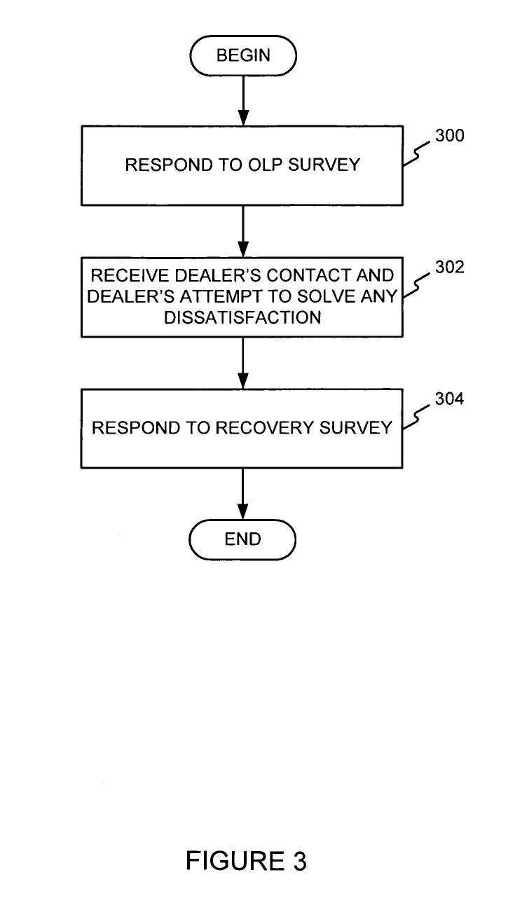

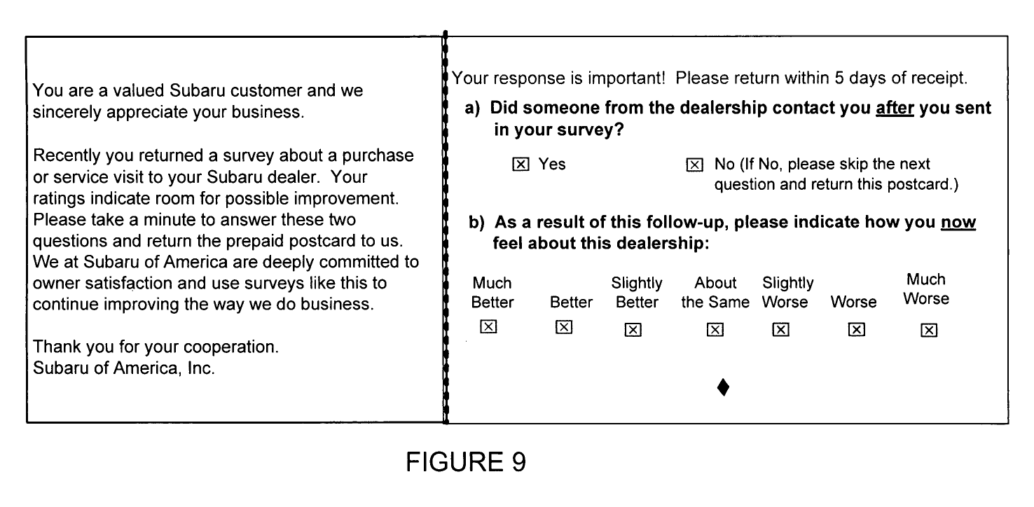

FIG. 3 is a flow chart illustrating an exemplary process for a customer to participate in a system for recovering dissatisfied customers consistent with an embodiment of the present invention. A customer who purchased a vehicle from a dealership may respond to an initial survey, such as the OLP survey (step 300). If the customer showed dissatisfaction in the response to the OLP survey, the customer may be contacted by the dealer in an attempt to solve any dissatisfaction (step 302). The customer may, for example, explain to the dealer why he or she was dissatisfied and how the dealer can fix the problem. If the customer receives a recovery survey, the customer may respond to the recovery survey (step 304). FIG. 9 is a sample recovery survey in accordance with one embodiment of the present invention. In accordance with this embodiment of the present invention, the recovery survey may include two simple questions. In one embodiment, in order to recover a customer and improve the SOLI score, Question a (Did someone from the dealership contact you after you sent in the survey?) must earn a “Yes” and Question b (As a result of this follow-up, please indicate how you now feel about this dealership) must receive a “Much Better” or “Better” rating.

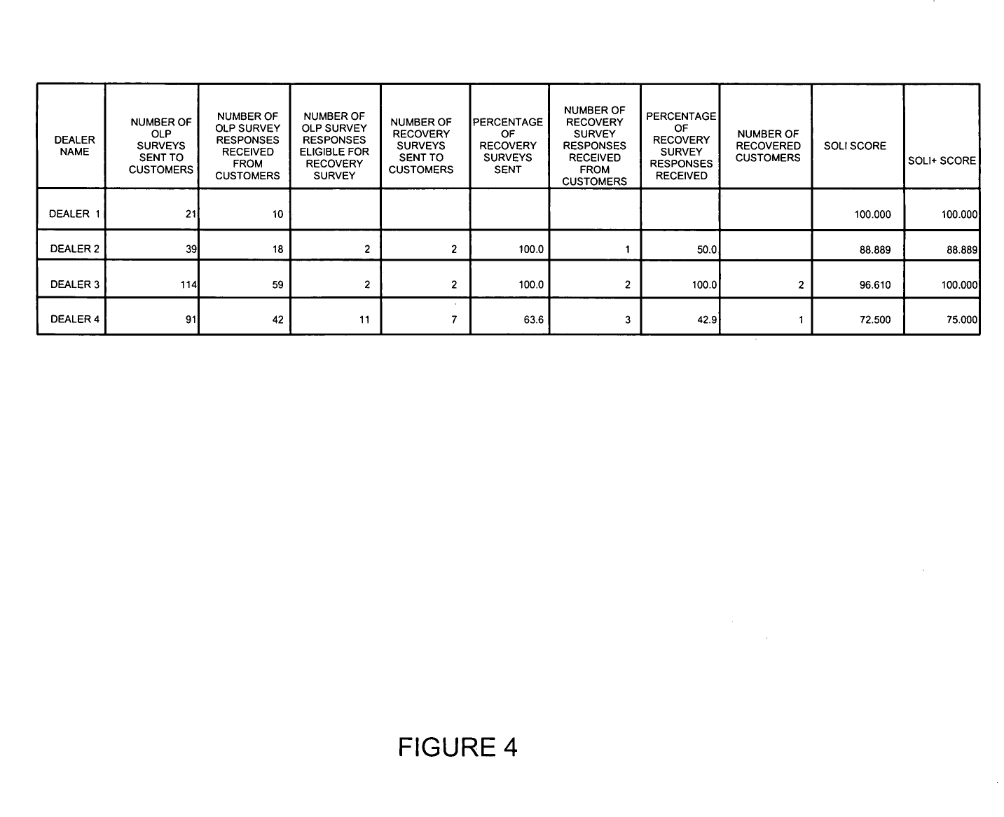

FIG. 4 is an exemplary recovery survey report in accordance with one embodiment of the present invention. In this example, Dealer 1 sent 21 OLP surveys to customers. Out of the 21 OLP surveys sent, Dealer 1 received 10 responses from customers. None of the 10 responses was eligible for a recovery survey because the responses were all positive. The SOLI Score was a perfect score of 100. The SOLI+ Score was also a perfect score of 100, showing no change from the SOLI Score.

Dealer 2 sent 39 OLP surveys to customers. Dealer 2 received 18 responses. Out of the 18 responses, 2 responses were eligible for a recovery survey because these 2 responses were negative. Dealer 2 sent 2 recovery surveys to the 2 dissatisfied customers who gave negative responses. The percentage of the recovery surveys sent was 100 because Dealer 2 sent out all of the 2 recovery surveys that were eligible. Dealer 2 received only one response from the 2 recovery surveys sent. The percentage of recovery survey responses received was therefore 50 (1 out of 2). Because the response to the recovery survey was negative, the number of recovered customers was 0. The SOLI Score was 88.889. Because Dealer 2 could not recover the dissatisfied customer, the SOLI+ Score was also 88.889, showing no change from the SOLI Score. In this example, Dealer 2 was not penalized for not recovering the dissatisfied customer because the updated SOLI+ Score was the same as the original SOLI Score. Dealer 3 sent 14 OLP surveys to customers. Dealer 3 received 59 responses. Out of the 59 responses, 2 responses were eligible for recovery surveys because these 2 responses were negative. Dealer 3 sent 2 recovery surveys to the 2 dissatisfied customers who gave negative responses. The percentage of the recovery surveys sent was 100 because Dealer 3 sent out all of the 2 recovery surveys that were eligible. Dealer 3 received 2 responses from the 2 recovery surveys sent. The percentage of recovery survey responses received was therefore 100. Because both of the 2 responses to the recovery surveys were positive, the number of recovered customers was 2. The SOLI Score was originally 96.610. In this example, because Dealer 3 was able to recover all of the two dissatisfied customers, the updated SOLI+ Score was a perfect score of 100. Therefore, Dealer 3 was able to boost the original SOLI Score to a perfect SOLI+ Score of 100 by recovering all of the dissatisfied customers.

Dealer 4 sent 91 OLP surveys to customers. Dealer 4 received 42 responses. Out of the 42 responses, 11 responses were eligible for recovery surveys because these 11 responses were negative. Dealer 4 sent 7 recovery surveys. The percentage of the recovery surveys sent was 63.6 because Dealer 4 sent 7 out of the 11 recovery surveys that were eligible. Dealer 4 received 3 responses from the 7 recovery surveys sent. The percentage of recovery survey responses received was 42.9. Because only 1 response to the recovery survey was positive, the number of recovered customers was 1. The SOLI Score was originally 72.5. Because Dealer 4 was able to recover 1 dissatisfied customer, the updated SOLI+ Score was increased to 75. In this example, dealer 4 was able to boost the original SOLI Score even though Dealer 4 could not recover all of his dissatisfied customers.

A skilled artisan will appreciate that other calculations may be used to determine an updated score, such as a SOLI+ score, based on the numbers of recovery surveys sent, the number of recovery surveys received, the number of positive responses to recovery surveys etc.

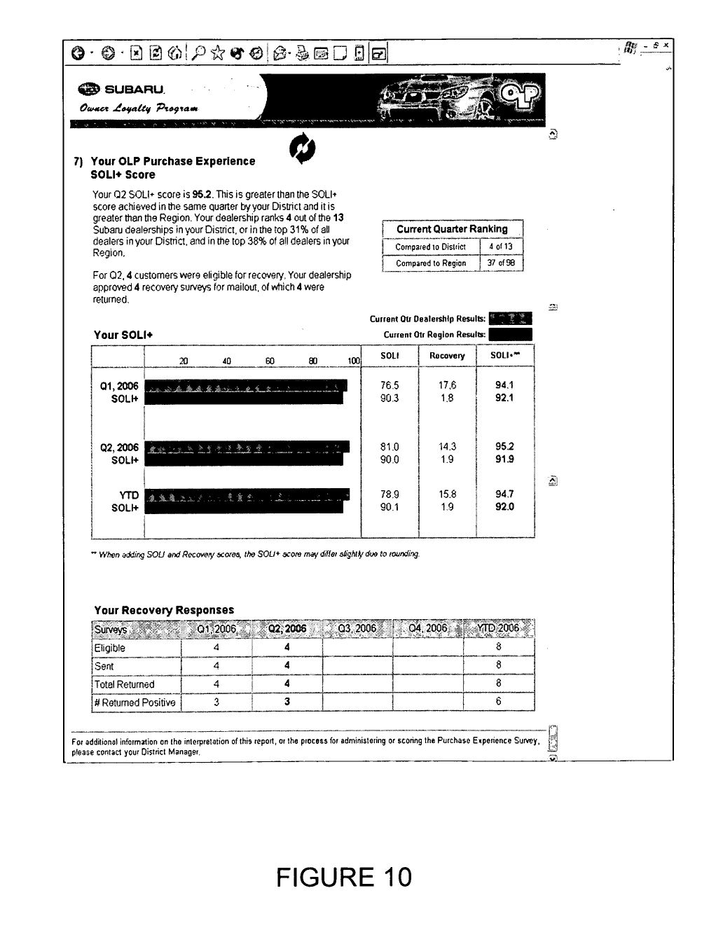

FIG. 10 is an exemplary individual dealer report in accordance with one embodiment of the present invention. In this example, the dealer may review his SOLI+ Score rankings in his district and in his region. The dealer in this example ranked 4th out of the 13 Subaru dealerships (top 31%) in his district and ranked 37th out of the 98 Subaru dealerships (top 38%) in his region. Therefore, the dealer is able to review his performance compared to other dealerships in his district or region.

A customer recovery survey system consistent with the present invention gives the dealership a second chance to recover a dissatisfied customer and also improve an initial bad survey score. This customer recovery survey system also allows a dealership and/or manufacturer to more accurately predict customer loyalty by updating the initial survey results.

One skilled in the art will recognize that many alternative embodiments are possible within the scope of the present invention. For example, the initial survey and/or the recovery survey may be sent by a dealer or a manufacturer or may be requested by a customer.

What is claimed is:

1. A method for recovering a dissatisfied customer, comprising:
sending an initial survey to a customer;
receiving a response to the initial survey from the customer;
calculating an initial score based on the response to the initial survey;
displaying the initial score and the response to the initial survey;
receiving a selection of a dissatisfied customer based on the displayed response to the initial survey;
sending a recovery survey to the selected dissatisfied customer;
receiving a response to the recovery survey from the selected dissatisfied customer;
updating the initial score based on the response to the recovery survey; and
displaying an updated score and the response to the recovery survey.

2. The method of claim 1, wherein the selection of the dissatisfied customer is based on a satisfaction score in the response to the initial survey.

3. The method of claim 1, wherein the initial score and the response to the initial survey are displayed online.

4. The method of claim 1, wherein the updated score and the response to the recovery survey are displayed online.

5. The method of claim 1, wherein updating further comprises:
increasing the initial score if the response to the recovery survey is positive.

6. The method of claim 1, wherein updating further comprises:
updating the initial score based on a number of responses to recovery surveys received.

7. The method of claim 1, wherein displaying the updated score and the response to the recovery survey further comprises:
displaying a number of recovered customers.

8. A method for recovering a dissatisfied customer, comprising:
receiving an initial report including a plurality of customer responses to an initial survey;
selecting a dissatisfied customer based on the dissatisfied customer's response to the initial survey;
contacting the selected dissatisfied customer;
sending a request for a recovery survey to be sent to the dissatisfied customer after the dissatisfied customer has been contacted; and
receiving an updated report including the dissatisfied customer's response to the recovery survey.

9. The method of claim 8, wherein selecting the dissatisfied customer further comprises:
selecting the dissatisfied customer based on a satisfaction score in the dissatisfied customer's response to the initial survey.

10. The method of claim 8, wherein the initial report further includes an initial score calculated based on the responses to the initial survey.

11. The method of claim 10, wherein the updated report further includes an updated score calculated based on the initial score and the dissatisfied customer's response to the recovery survey.

12. The method of claim 8, wherein the initial report is an online report.

13. The method of claim 8, wherein the updated report is an online report.

14. The method of claim 8, wherein the request for the recovery survey is sent online.

15. A system for recovering a dissatisfied customer, comprising:
an initial survey sending component configured to send an initial survey to a customer;
an initial survey response receiving component configured to receive a response to the initial survey from the customer;
an initial score calculating component configured to calculate an initial score based on the response to the initial survey;
an initial score displaying component configured to display the initial score and the response to the initial survey;
a selection receiving component configured to receive a selection of a dissatisfied customer based on the displayed response to the initial survey;
a recovery survey sending component configured to send a recovery survey to the selected dissatisfied customer;
a recovery survey response receiving component configured to receive a response to the recovery survey from the selected dissatisfied customer;
an updated score calculating component configured to calculate and update the initial score based on the response to the recovery survey; and
an updated score displaying component configured to display an updated score and the response to the recovery survey.

16. The system of claim 15, wherein the selection of the dissatisfied customer is based on a satisfaction score in the response to the initial survey.

17. The system of claim 15, wherein the initial score and the response to the initial survey are displayed online.

18. The system of claim 15, wherein the updated score and the response to the recovery survey are displayed online.

19. The system of claim 15, wherein the updated score calculating component increases the initial score if the response to the recovery survey is positive.

20. The system of claim 15, wherein the updated score calculating component updates the initial score based on a number of responses to recovery surveys received.
